(19) United States
(12) Patent Application Publication
(10) Pub. No.: US 2005/0015358 A1
(43) Pub. Date: Jan. 20, 2005

(54) Method of automatically recognizing configuration information units of experimental data and patterns of array rules and storage medium therefor

(76) Inventor: Kyung-Yang Min, Seoul (KR)

Correspondence Address: MORGAN & FINNEGAN, L.L.P., 345 Park Avenue, New York, NY, 10154-0053, US

(21) Appl. No.: 10/886,862

(22) Filed: Jul. 8, 2004

(30) Foreign Application Priority Data
Jul. 16, 2003 (KR) 2003-48897

(51) Int. Cl. G06F 7/00

(52) U.S. Cl. 707/1

(57) ABSTRACT

There is provided a method of automatically recognizing configuration information units of experimental data and patterns of the array rules, the method comprising: a classification step of receiving experimental data measured by a measurement instrument, extracting characteristics of information associated with measurement, delimiters, and information units associated with settings of the measurement instrument, identifying characters and numerals contained in each of the information units, and classifying the experimental data into groups; and an identification-data outputting step of determining whether or not the classified data groups have predetermined array rules, recognizing a change of patterns of the array rules, and outputting identified data in accordance with the recognized patterns of the array rules.

### BACKGROUND OF THE INVENTION

1. Field of the Invention

The present invention relates to a method of automatically recognizing configuration information units of experimental data and patterns of array rules, and more particularly, to a method of automatically recognizing basic information units of raw data, delimiters for delimiting the basic information and information units associated with settings of the measurement instrument, wherein the raw data obtained by different measurement instruments has different data formats, and wherein the patterns of the array rules are determined based upon the relative positions of the basic information units in the raw data.

2. Description of the Related Art

PLC (programmable logic controller) is necessary for process control automation. In the PLC, since basic information units of raw data are arranged in a predetermined sequence and bytes of the basic information units of the raw data stored in a memory are fixed in accordance with a predetermined schedule, it is easy to identify an recognize the data formats and patterns of the array rules.

On the other hand, the information units in raw data obtained with different measurement instruments have different memory sizes. In addition, the number and array sequences of the information units of raw data change in a real time. Therefore, a general-purpose algorithm commonly used for the different measurement instruments has not been developed. As a result, commercial application software can only provide a development environment, not a solution.

For this reason, a user of a measurement instrument has to spend too much time constructing a routine for recognizing a data format obtained with the measurement instrument in accordance with a predetermined data format based on the manual of the measurement instrument.

One of the principal tasks of scientists and engineers fulfilling a project in a laboratory or an industrial workplace is to measure, control, monitor, analyze and manage the measured data in a real time from various measurement instruments or plug-in I/O boards which are connected to a computer.

The scientists and engineers spend much time on developing software or modifying and debugging commercial software to fulfill the project. The development, modification, and debugging of the software are not principal tasks of the scientists and engineers. Therefore, resources (personnel and time) are wasted and productivity is lowered.

There is another problem in that software developed for a particular measurement instrument or customized software depends on a data format stored in the measurement instrument so that the particular software cannot be used for other measurement instruments. Since there is no general-purpose algorithm for automatically recognizing various data formats obtained from different measurement instruments, particular software is needed for particular measurement instruments.

There is a parsing method that is used to automatically recognize configuration information units of experimental data and patterns of the array rules from a measurement instrument. That parsing method is based on a script or an interpreter. However, that parsing method is not suitable due to following reasons.

First, the time slicing allocated to the script of the CPU has lower priority than the time slicing allocated to the compiler. In a case where the data measured by the measurement instrument is analyzed by using application software having a higher priority in a CPU, if an array of basic information units of raw data changes rapidly in a real time, a large amount of data may be lost

Second, in a case where the patterns of the array rules dynamically change, since the data can not be recognized, the previously-constructed script is not flexible. Therefore, it is necessary to develop a general-purpose algorithm having high speed (1/1000 sec in an industrial standard time resolution) and based on a compiler.

### SUMMARY OF THE INVENTION

In order to solve the problems, an object of the present invention is to provide a method of automatically recognizing basic information units of raw data and delimiters for delimiting the basic information, and information units associated with settings of measurement instruments wherein the raw data obtained by different measurement instruments has different data formats and the patterns of the array rules are determined based upon the relative positions of the basic information units in the raw data.

According to an aspect of the present invention, there is provided a method of automatically recognizing configuration information units of experimental data and patterns of the array rules, the method comprising: a classification step of receiving experimental data measured by a measurement instrument, extracting characteristics of information associated with measurement, delimiters, and information units associated with settings of the measurement instrument, identifying characters and numerals contained in each of the information units, and classifying the experimental data into groups; and an identification-data outputting step of determining whether or not the classified data groups have predetermined array rules, recognizing a change of patterns of the array rules, and outputting identified data in accordance with the recognized patterns of the array rules.

According to another aspect of the present invention, there is provided a storage medium for storing a program for automatically recognizing configuration information units of experimental data and patterns of the array rules, wherein the program comprises: a classification process for receiving experimental data measured by a measurement instrument, extracting characteristics of information associated with measurement, delimiters, and information units associated with settings of the measurement instrument, identifying characters and numerals contained in each of the information units, and classifying the experimental data into groups; and an identification-data outputting process for determining whether or not the classified data groups have predetermined array rules, recognizing a change of patterns of the array rules, and outputting identified data in accordance with the recognized patterns of the array rules

According to still another aspect of the present invention, there is provided a system of automatically recognizing configuration information units of experimental data and patterns of the array rules, the system comprising: an edit module for allowing a user to select a control command from a manual, input the command and input the command to measurement instrument; a measurement module comprising a communication protocol and particular software provided by a manufacturer of the measurement instrument; a filter module comprising an algorithm for automatically recognizing the configuration information units and the patterns of the array rules, the filter module for filtering the measured data of a predetermined experiment, displaying the filtered data, and allocating basic information, delimiters, and information units associated with settings of the measurement instrument to global variables or array variables; a data handler module for adjusting loop variable values or generating new array variables by combining global variable values and array variable values, calculating measured values in accordance with an array order of bytes required by a manual in a case where binary data is obtained, and generating a dynamic link library by compiling codes with an embedded complier, wherein the array order is determined in accordance with relative positions of MSB and LSB; and a branch module for providing a branching condition on the loop variable in a case where there are a plurality of query commands specified by the edit module.

### BRIEF DESCRIPTION OF THE DRAWINGS

The above and other features and advantages of the present invention will become more apparent by describing in detail exemplary embodiments thereof with reference to the attached drawings in which:

FIGS. 1a and 1b are flowcharts for explaining a method of automatically recognizing configuration information units of experimental data and patterns of array rules according to the present invention;

FIG. 2 is a block diagram illustrating components used to implement the method of FIGS. 1a and 1b;

FIG. 3 is a view illustrating a configuration (Config.) on a user interface;

FIG. 4a to 4c are views illustrating filter outputs on a user interface; and

FIG. 5 is a view illustrating FIGS. 3 and 4 on one screen.

### DETAILED DESCRIPTION OF THE INVENTION

Now, the preferred embodiments according to the present invention will be described in details with reference to the accompanying drawings.

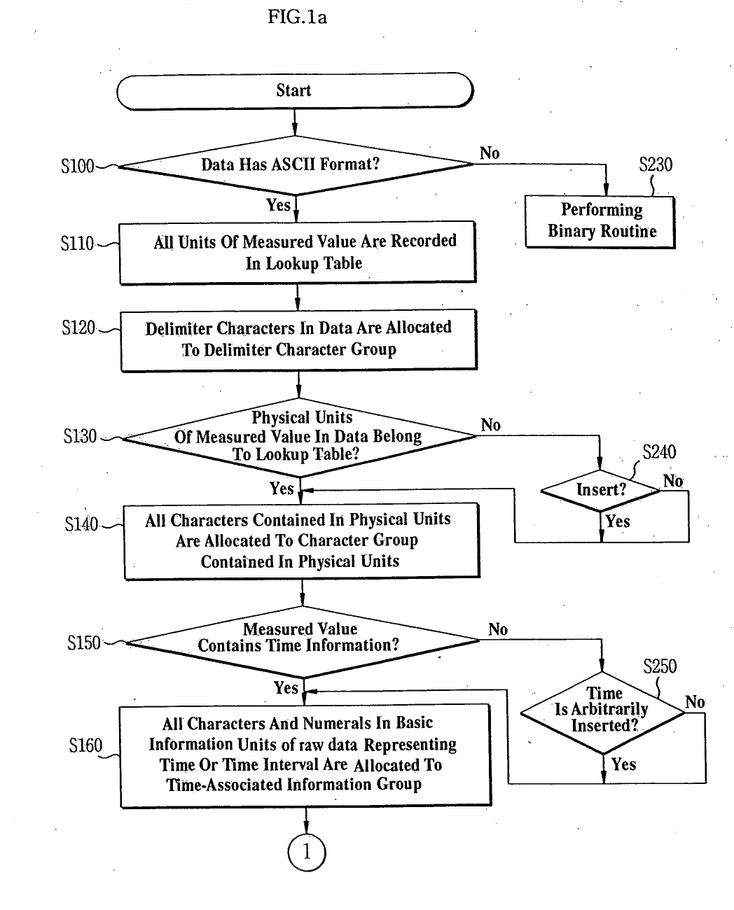

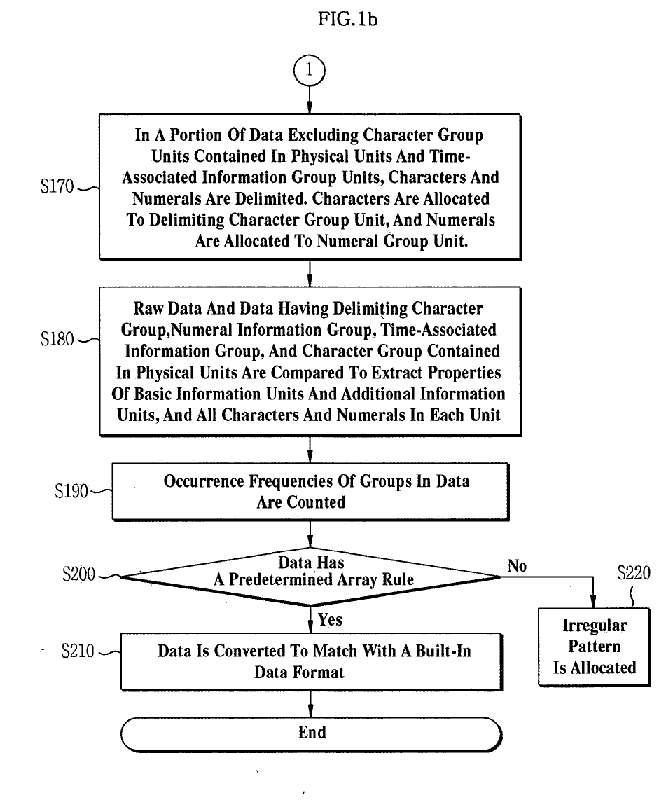

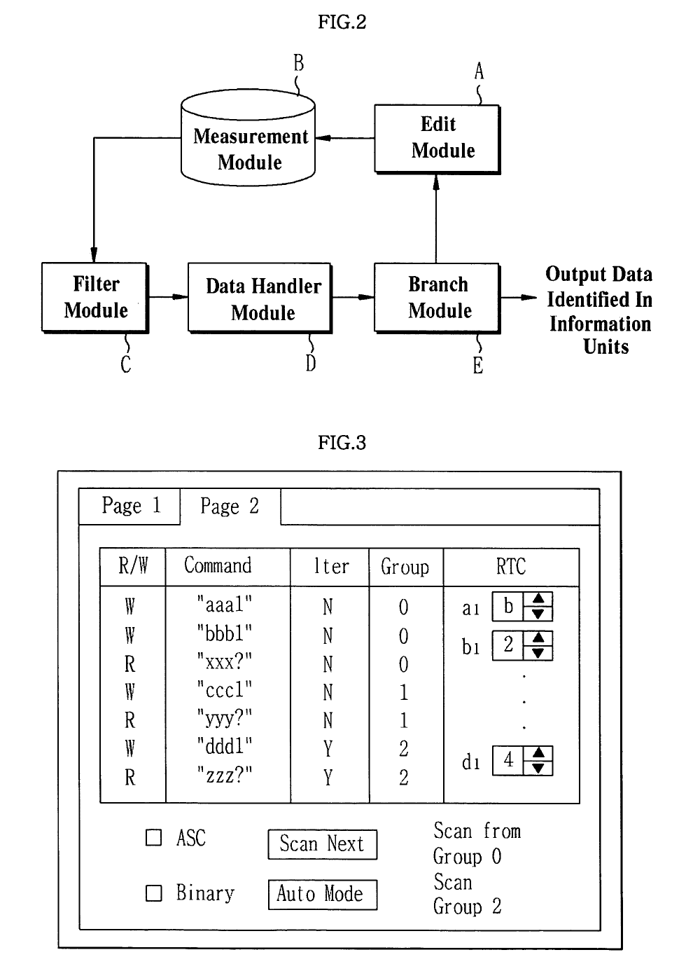

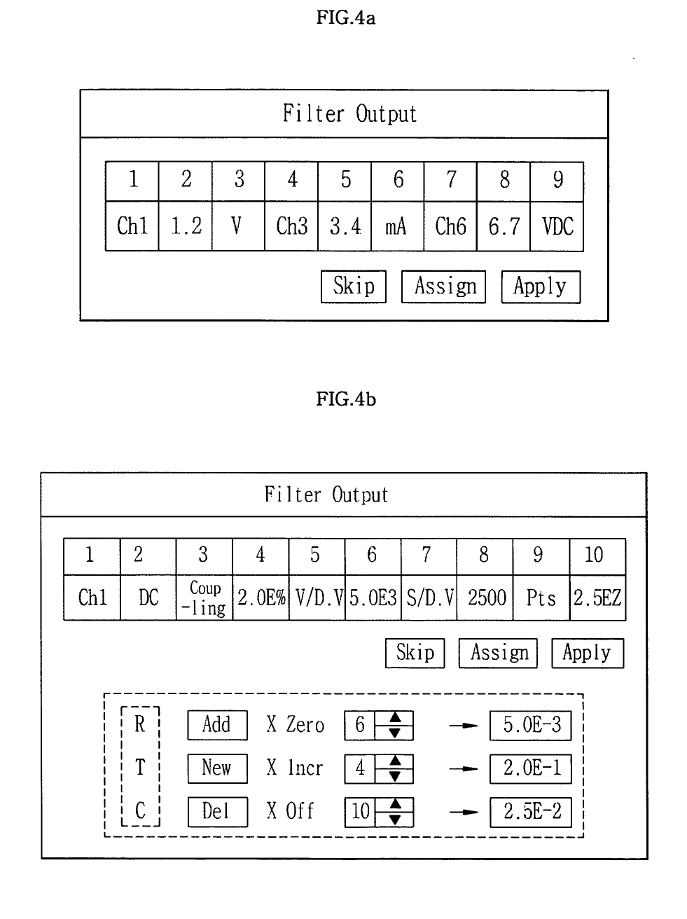

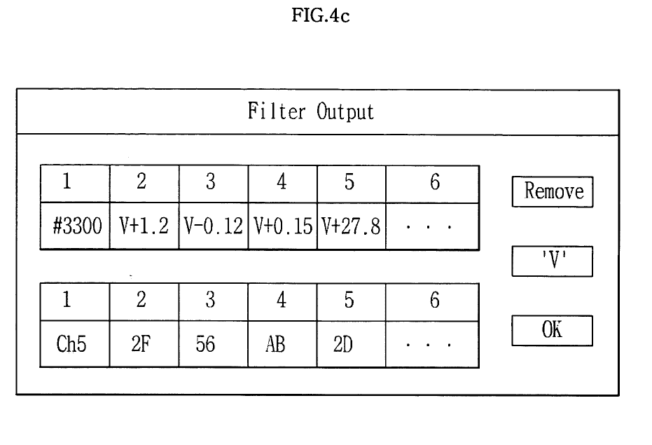

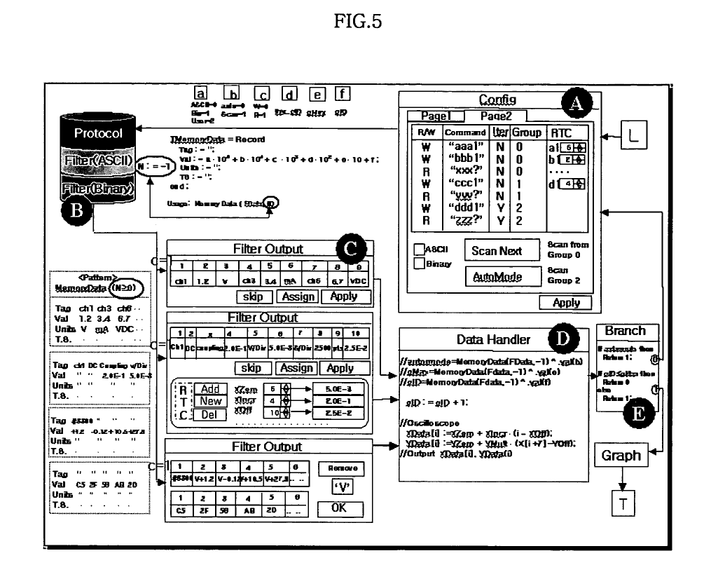

FIGS. 1a and 1b are flowcharts for explaining a method of automatically recognizing configuration information units of experimental data and patterns of array rules according to the present invention; FIG. 2 is a block diagram illustrating components used to implement the method of FIGS. 1a and 1b; FIG. 3 is a view illustrating a configuration on a user interfaces; and FIG. 4a to 4c are views illustrating filter outputs on a user interface.

In order to implement the method shown in FIGS. 1a and 1b, the measurement instrument is first interfaced with a computer, and a data acquisition process is performed. At this time, the user inputs control commands in accordance with the manual provided by the manufacture to the measurement instrument through a communication protocol such as RS232, GPIB, and Ethernet.

Control commands are mainly classified into a non-query command without the question mark “?” and query command with the question mark “?”. The non-query command is used for settings of the measurement instrument and settings of the configuration, and does not demand any responses from the measurement instrument. On the other hand, the query command is used to request the measurement instrument for information including measured values. The measurement instrument processes data corresponding to the command to match with a data format and outputs the processed data, so that the processed data can be recognized by the user.

Since there are various data formats for the data provided by the measurement instruments, the user makes identification routines for the measurement instruments for identification and determination of the data. The data provided by the measurement instruments generally has basic information units of raw data including measured values, representative names of the measured values (identifiers), physical units of the measured values, and time stamps of the measured values.

In order to delimit the basic information units, delimiters such as the symbols: quotation mark (“); comma (,); colon (;); semicolon (:); blank ( ); and slash (/), particular symbols (including terminators such as “carriage return”, and “line feed”), an identifier of the measurement instrument, and delimiters for delimiting the basic information, and information units associated with settings of measurement instruments, may be included and transmitted in an ASCII or binary format through an interface.

Each of the measurement instruments interprets and recognizes data in different ways and it is difficult to make a program for the interpretation and recognition of the data. That is because an identifier having numerals, for example, “channel 23” may be confused as a measured value. In addition, that is because there are many kinds of delimiters. That is because the number of measured values in the data (for example, the numbers of identifiers, physical units, and time stamps) varies in accordance with user's request, and the numerical format of the measured value may vary in accordance with the user's request. For example, there are two formats for representing one measured value: 0.123 and 1.23E−01.

In addition, since the array sequence of the basic information units of raw data used in the measurement instruments are different and thus the relative positions thereof are different among measurement instruments, and the relative positions may vary in accordance with the user's request, it is difficult to make the program. For example, even in a case where the number of the measured values is fixed, the array of the measured values may vary in accordance with configuration of the query commands.

In addition, since patterns of the array rules used to provide the basic information units to the user vary in a real time, the variation has to be accurately recognized. Therefore, it is difficult to make the program.

Now, raw data measured by the measurement instrument and identified data automatically recognized in accordance the present invention will be described.

The basic information units of raw data and the patterns of array rules thereof have some patterns of the array rules.

1. Pattern 1

In Pattern 1, only the measured values are iterated with Period 1.

Raw Data: +3.0, 1.5, +2.5, 0.4E+3, +1.3

Identified Data:

| | | | | |
|---|---|---|---|---|
| +3.0 | 1.5 | +2.5 | 0.4E+3 | +1.3 |

2. Pattern 2

In Pattern 2, the identifiers and the measured values are alternately iterated with Period 2.

Raw Data: CH2: +1.07E+1: CH3: +7.05E+1: CH4: −1.32E-1: CH5: +3.25E+3:

Identified Data

| CH2 | CH3 | CH4 | CH5 |
|---|---|---|---|
| +1.07E+1 | +7.05E+1 | −1.32E−1 | +3.25E+3 |

3. Pattern 3

In Pattern 3, the identifiers, the measured values, and the measurement units are alternately iterated with Period 3.

Raw Data: CH1, +1.0E+2, VDC; CH2, −5.0E−1, VDC; CH3, +2.0E+1, VDC

Identified Data

| CH1 | CH2 | CH3 |
|---|---|---|
| +1.0E+2 | −5.0E−1 | +2.0E+1 |
| VDC | VDC | VDC |

4. Pattern 4

In Pattern 4, the identifiers, the measured values, the measurement units, and the time stamps are alternately iterated with Period 4.

Raw Data: CH1, +1.0E+1, mV, May 23, 2003 AM 9:40, CH2, −2.3E-1, mA, May 23, 2003 AM 9:40

Identified Data

| CH1 | CH2 |
|---|---|
| +1.0E+1 | −2.3E−1 |
| mV | mV |
| 2003-05-23 AM 9:40 | 2003-05-23 AM 9:40□ |

5. Pattern 5

In Pattern 5, after one delimiter and one information unit associated with the settings of the measurement instrument, the measured values are alternately iterated with Period 1.

Raw Data: #3300, V+1.23, V−0.12, V+10.5, V+27.8,

Identified Data

| | | | | |
|---|---|---|---|---|
| #3300 | +1.23 | −0.12 | +10.5 | +27.8 |

6. Pattern 6

In Pattern 6, delimiters for delimiting the basic information, information units associated with settings of measurement instruments, and one basic information units of measured values are arrayed without any periodicity.

Raw Data: CH1 DC COUPLING+2.0E−1 V/DIV+5.0E−3 S/DIV

Identified Data

| | | | | | | |
|---|---|---|---|---|---|---|
| CH1 | DC | COUPLING | +2.0E−1 | V/DIV | +5.0E−3 | S/DIV |

As can be seen in the above examples, it can be understood that basic information units of raw data, delimiters for delimiting the basic information, and information units associated with settings of measurement instruments can be automatically recognized, and the patterns of the array rules determined with relative positions of the basic information units in raw data can be recognized. Here, the raw data obtained by different measurement instruments during data acquisition has different data formats.

Now, a process for identifying the basic information units of raw data, the delimiters for delimiting the basic information, and information units associated with settings of measurement instruments, characters and numerals in the basic information units will be described with reference to FIGS. 1a and 1b. Here, the process is executed by an automatic recognition program loaded on a computer.

First, if the data has an ASCII format, all the units of the measured value are recorded in a lookup table (S100 and S110). If the data does not have the ASCII format, a binary routine is performed by the automatic recognition program loaded on the computer (S230).

The delimiters such as symbols: quotation mark (‘’); comma (,); colon (;); semicolon (:); blank ( ); and slash (/), and information associated with the settings of the measurement instrument included in the data are classified into groups by the automatic recognition program (S120).

Next, it is determined by the automatic recognition program whether or not physical units of the measured value in the data belong to the lookup table. All the characters contained in the physical units are classified into character groups (S130 and S140). If the physical units do not belong to the lookup table, it is determined whether or not the user inserts physical units (S240). If the user inserts the physical units, the aforementioned step S140 is performed on the inserted physical units by the automatic recognition program. If the user does not insert the physical units, the aforementioned step S140 is performed on only the input data.

Next, it is determined by the automatic recognition program whether or not the measured value contains time information (S150). More specifically, it is determined whether or not the measured value contains basic information units associated with a given time or a time interval with respect to a reference time. In case of “time”, it is determined whether or not the year, month, day, hour, minute, sec, msec, and so on are connected with symbols such as dash), comma (,), and slash (/). In case of “time interval”, it is determined whether or not there are time units of “minutes”, “sec”, “msec”, and so on. All the characters and numerals in basic information units representing time or time interval are classified into time-associated information groups (S160). If there is no time information in the measured value, it is determined whether or not the user inputs time. If the user inputs time, the step S160 is performed on the time input by the user. If the user does not input time, the step S160 is performed on only the input data.

In addition, in a portion of data excluding character group units contained in the physical units, and time-associated information group units, characters of ‘.’, ‘a’, ‘b’, ‘c’, and “ and numerals of 0, 1, 2, 3, +, and − are delimited. In a case where the characters are contained, the delimiters and information associated with the settings of the measurement instrument are classified into groups by the automatic recognition program.

Next, when the numerals are contained, the numerals are classified into numeral groups by the automatic recognition program (S170).

In a case where the characters and numerals are mixed, the numerals contained in the numeral sequence are replaced with the delimiters and the information group units associated with the settings of the measurement instrument instead of the numeral group units. In the case of the symbols “.” and “E” (or “e”) occurring between the numerals, the numerals contained in the numeral sequence are replaced with the numeral group units instead of the delimiters and the information group units associated with the settings of the measurement instrument. The symbol of ‘.’ means decimal point, and the symbols of ‘E’ and ‘e’ mean an exponential number.

In addition, since the delimiters classified as a character group are disposed at the beginning or ending portions of information group units associated with the settings of the measurement instrument, the delimiters are separately identified and removed from the information group units by using an automatic recognition program installed in a computer.

Next, the data replaced with the delimiters and the information groups associated with the settings of the measurement instrument, the numeral group, the time information group, and the character group contained in the physical units are compared with the raw data to extract characteristics of the information units associated with measurement, the delimiters, and the information units associated with settings of measurement instruments, and all characters and numerals in the units (S180).

In a case where a large amount of data is dumped into a computer by an oscilloscope, a spectrum analyzer, or the like, a binary transmission method is used in consideration of transmission speed. In most cases, the measured value has four bytes or less. In order to obtain binary data, an user interface is provided to calculate the measured value in accordance with a byte sequence, that is, little endian and big endian.

Through the steps S100-18 S180, the delimiters, the information associated with the settings of the measurement instrument, the numeral group, the time information, the character group units contained in the physical units can be classified. Through another scanning process, the occurrence frequencies of the groups in the data are counted (S190), and it is determined whether or not the data has a predetermined array rule (S200). In case of the occurrence frequencies being different, when there is not a predetermined array rule, the data is classified into an irregular pattern by the automatic recognition program (S220). In case of the occurrence frequencies being equal, it is determined whether or not the information units alternately occur in accordance with a predetermined array rule by using another scanning process. When there is the predetermined array rule, the data is converted to match with the built-in data format (S210).

Now, interfaces using the filtering algorithm according to the present invention will be described with reference to FIGS. 2 to 4.

In the edit module (A), the user selects the control commands from a manual and inputs the control commands on the window shown in FIG. 3. The input control commands are transmitted to the measurement instrument.

The measurement module (B) and the filter module (C) display filtered data as shown in FIG. 4a after a predetermined experiment are made. The measurement module (B) comprises communication protocol and unique software provided by a manufacturer of the measurement instrument. The filter module (C) comprises an algorithm for automatically recognizing the configuration information units and the patterns of the array rules according to the present invention. In the measurement module (B) and the filter module (C), the basic information units, the delimiters, and information units associated with settings of measurement instruments are allocated to the global variables or the array type variables.

In the data handler module (D) of the measurement instrument according to the present invention, a value of the loop variable used for the branch module (E) are adjusted, or new array type variables are generated by combining values stored in the global variables and values stored in the array type variables. If binary type data is obtained, the measured values are calculated in accordance with an array order of bytes in the manual, and codes generated by the computer are compiled to generate an execution module, that is, a DLL (dynamic link library) module. Here, the array order of bytes means relative position of MSB and LSB.

Finally, in a case where there are two or more query commands set in the edit module (A), that is, a case where two or more responses are expected to be transmitted from the measurement instrument, the branch module (E) provides branching conditions of loop variables so that the edit module (A) can be iteratively used. The branch module (E) functions as a medium for transmitting a set (Record or Structure) of the basic information unit “TMemoryData,” where N>=0. If N=−1, the branch module (E) transmits the later-described specific information units about setting of the edit module (A).

Now, the edit module (A), the measurement module (b), and the filter module(C) will be described with reference to FIG. 5.

1. Edit Module (A)

In the table, the first column (R/W) corresponds to W (write) or R (read) in accordance with a non-query command or a query command. The second column (Command) represents the control commands selected from a manual. The third column (Iter) represents whether or not the command has to be iteratively sent in real time. The fourth column (Group) represents indexes used for grouping all the commands with reference to the query commands. In case of query commands, only if a response to a query command is received, can the next query command be sent.

A packet (a, b, c, d, e, and f) comprising the data of the column information and the data of the ASCII and binary information are transmitted from the edit module 100 to the measurement module 200. In the fifth column (RTC), RTC (Runtime Control) components necessary to dynamically change control commands are generated, and the user modifies the RTC in a real time to dynamically change contents and patterns of the response data.

2. Measurement Module (B)

The measurement module comprises a protocol corresponding t a hardware interface for communication between the measurement instrument and a computer system in which a program according to the present invention is installed.

3. Filter Module (C)

The filter module selects and executes an ASCII filter or a binary filter based on information contained in a packet and displays results of filtering on the Modal window shown in FIG. 4a.

4. Window (D) of Filter Module

The results of the filtering are depicted in a grid format. In case of a periodical pattern of the array rules, the user pushes button “Skip” (see the first window in FIG. 4a) or stores the measured values in array type global variables (see the third window in FIG. 4a). In case of an aperiodic pattern of the array rules, the user creates global variables such as XZero, XIncr, XOff (see FIG. 4b), allocates indexes to the global variables, and store values of the basic information units of raw data to the global variables. The indexes represent relative positions of the basic information units in data. Here, the aperiodicity of the patterns is caused by aperiodicity of the delimiters and the information units associated with settings of measurement instruments.

According to the present invention, since the program can be used for different instruments, it is possible to automatically recognize data formats of different measurement instruments. It is thus possible to effectively reduce development time of software.

In addition, according to the present invention, since users (scientists and engineers) of measurement instruments need not spend much time on developing software for the measurement instrument, the users can focus on their own principal tasks, so that it is possible to increase productivity remarkably.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A method of automatically recognizing configuration information units of experimental data and patterns of the array rules, the method comprising:
a classification step of receiving experimental data measured by a measurement instrument, extracting characteristics of information associated with measurement, delimiters, and information units associated with settings of the measurement instrument, identifying characters and numerals contained in each of the information units, and classifying the experimental data into groups; and
an identification-data outputting step of determining whether or not the classified data groups have predetermined array rules, recognizing a change of patterns of the array rules, and outputting identified data in accordance with the recognized patterns of the array rules.

2. The method according to claim 1, wherein the classification step comprises:
in a case where the data output in an initial data output step is of an ASCII format, generating a lookup table for entire list of units of a particular value;
classifying delimiters contained in the data into delimiters and the information groups associated with the settings of the measurement instrument;
in a case where a physical unit of the measured value contained in the data is listed in the lookup table, classifying characters contained in the physical unit into a character group contained in the physical unit;
determining whether or not time information is contained in the measured value, and classifying all the character and numerals in a basic information unit representing time or time interval into a time-associated information group;
delimiting characters and numerals in a portion of data excluding the character group units contained in the physical unit and time-associated information group unit, classifying the characters into the delimiters and the information groups associated with the settings of the measurement instrument, and classifying the numerals into a numeral group;
comparing data including the delimited character group, the numeral group, the time-associated information group, and the character group contained in the physical units with raw data, and extracting characteristics of the basic information units associated with the measurement, the delimiters, and the information groups associated with the settings of the measurement instrument and all the characters or numerals contained in the units; and
checking occurrence frequencies of the classified groups in the data, and outputting the frequencies in an embedded data format.

3. The method according to claim 1, wherein the basic information comprises at least one of the measured value, an identifier of the measured value, a physical unit of the measured value, and a measurement time, and
wherein the delimiters and information associated with the settings of the measurement instrument comprises delimiters for delimiting basic units in the data, special symbols, the measurement instrument identifiers, delimiters associated with the settings of the measurement instrument, and information units associated with settings of the measurement instrument in the data.

4. The method according to claim 2, wherein the classification step further comprises a step of, in a case where there are character sequences and numeral sequences in the recognized data, replacing numerals in the numeral sequences with the delimiters and the information groups associated with the settings of the measurement instrument instead of the numeral group, and in a case where there is character “E” between numerals, replacing the character “E” with the numeral group instead of the delimiters and the information groups associated with the settings of the measurement instrument.

5. A storage medium for storing a program for automatically recognizing configuration information units of experimental data and patterns of the array rules, wherein the program comprises:
a classification process for receiving experimental data measured by a measurement instrument, extracting characteristics of information associated with measurement, delimiters, and information units associated with settings of the measurement instrument, identifying characters and numerals contained in each of the information units, and classifying the experimental data into groups; and
an identification-data outputting process for determining whether or not the classified data groups have predetermined array rules, recognizing a change of patterns of the array rules, and outputting identified data in accordance with the recognized patterns of the array rules

6. The storage medium according to claim 5, wherein the classification process comprises processes for:
in a case where the data output in the identification data outputting process is of an ASCII format, generating a lookup table for entire list of units of a particular value;
classifying delimiters contained in the data into delimiters and the information groups associated with the settings of the measurement instrument;
in a case where a physical unit of the measured value contained in the data is listed in the lookup table, classifying characters contained in the physical unit into a character group contained in the physical unit;
determining whether or not time information is contained in the measured value, and classifying all the character and numerals in a basic information unit representing time or time interval into a time-associated information group;
delimiting characters and numerals in a portion of data excluding the character group units contained in the physical unit and time-associated information group unit, classifying the characters into the delimiters and the information groups associated with the settings of the measurement instrument, and classifying the numerals into numeral group;
comparing data including the delimited character group, the numeral group, the time-associated information group, and the character group contained in the physical units with raw data, and extracting characteristics of the basic information units associated with the measurement, the delimiters, and the information groups associated with the settings of the measurement instrument and all the characters or numerals contained in the units; and
checking occurrence frequencies of the classified groups in the data, and outputting the frequencies in an embedded data format.

7. The storage medium according to claim 5,
wherein the data includes basic information comprising at least one of the measured value, an identifier of the measured value, a physical unit of the measured value, and a measurement time, and
wherein the data further includes delimiters for delimiting basic units in the data, special symbols, measurement instrument identifiers, delimiters associated with the settings of the measurement instrument, and information units associated with settings of the measurement instrument.

8. The storage medium according to claim 6, wherein the classification process further comprises a process for, in a case where there are character sequences and numeral sequences in the recognized data, replacing numerals in the numeral sequences with the delimiters and the information groups associated with the settings of the measurement instrument instead of the numeral group, and in a case where there is character “E” between numerals, replacing the character “E” with the numeral group instead of the delimiters and the information groups associated with the settings of the measurement instrument.

9. A system of automatically recognizing configuration information units of experimental data and patterns of the array rules, the system comprising:
an edit module for allowing a user to select a control command from a manual and input the command and input the command to measurement instrument;
a measurement module comprising a communication protocol and particular software
a filter module comprising an algorithm for automatically recognizing the configuration information units and the patterns of the array rules, the filter module for filtering the measured data of a predetermined experiment, displaying the filtered data, and allocating basic information, delimiters, and information units associated with settings of the measurement instrument to global variables or array variables;
a data handler module for adjusting loop variable values or generating new array variables by combining global variable values and array variable values, calculating measured values in accordance with an array order of bytes required by a manual in a case where binary data is obtained, and generating a dynamic link library by compiling codes with an embedded complier, wherein the array order is determined in accordance with relative positions of MSB and LSB; and
a branch module for providing a branching condition on the loop variable in a case where there are a plurality of query commands specified by the edit module.

10. The system according to claim 9, wherein the filter module performs operations for:
in a case where the filtered data is of an ASCII format, generating a lookup table for entire list of units of a particular value;
classifying delimiters contained in the data into delimiters and the information groups associated with the settings of the measurement instrument;
in a case where a physical unit of the measured value contained in the data is listed in the lookup table, classifying characters contained in the physical unit into a character group contained in the physical unit;
determining whether or not time information is contained in the measured value, and classifying all the character and numerals in a basic information unit representing time or time interval into a time-associated information group; and
delimiting characters and numerals in a portion of data excluding the character group units contained in the physical unit and time-associated information group unit, classifying the characters into the delimiters and the information groups associated with the settings of the measurement instrument, and classifying the numerals into a numeral group.

11. The system according to claim 9, wherein the filter module performs operations of:
comparing data including the delimited character group, the numeral group, the time-associated information group, and the character group contained in the physical units with raw data, and extracting characteristics of the basic information units associated with the measurement, the delimiters, and the information groups associated with the settings of the measurement instrument and all the characters or numerals contained in the units; and
checking occurrence frequencies of the classified groups in the data, and outputting the frequencies in an embedded data format.

12. The system according to claim 9,
wherein the data includes basic information comprising at least one of the measured value, an identifier of the measured value, a physical unit of the measured value, and a measurement time, and
wherein the data further includes delimiters for delimiting basic units in the data, special symbols, measurement instrument identifiers, delimiters associated with the settings of the measurement instrument, and information units associated with settings of the measurement instrument.

13. The system according to claim 10, wherein the filter module performs operations of:
in a case where there are character sequences and numeral sequences in the recognized data, replacing numerals in the numeral sequences with the delimiters and the information groups associated with the settings of the measurement instrument instead of the numeral group; and
in a case where there is character “E” between numerals, replacing the character “E” with the numeral group instead of the delimiters and the information groups associated with the settings of the measurement instrument.

14. The method according to claim 2, wherein the basic information comprises at least one of the measured value, an identifier of the measured value, a physical unit of the measured value, and a measurement time, and
wherein the delimiters and information associated with the settings of the measurement instrument comprises delimiters for delimiting basic units in the data, special symbols, the measurement instrument identifiers, delimiters associated with the settings of the measurement instrument, and information units associated with settings of the measurement instrument in the data.

15. The storage medium according to claim 6,
wherein the data includes basic information comprising at least one of the measured value, an identifier of the measured value, a physical unit of the measured value, and a measurement time, and
wherein the data further includes delimiters for delimiting basic units in the data, special symbols, measurement instrument identifiers, delimiters associated with the settings of the measurement instrument, and information units associated with settings of the measurement instrument.

16. The system according to claim 10, wherein the filter module performs operations of:
comparing data including the delimited character group, the numeral group, the time-associated information group, and the character group contained in the physical units with raw data, and extracting characteristics of the basic information units associated with the measurement, the delimiters, and the information groups associated with the settings of the measurement instrument and all the characters or numerals contained in the units; and
checking occurrence frequencies of the classified groups in the data, and outputting the frequencies in an embedded data format.

17. The system according to claim 10,
wherein the data includes basic information comprising at least one of the measured value, an identifier of the measured value, a physical unit of the measured value, and a measurement time, and
wherein the data further includes delimiters for delimiting basic units in the data, special symbols, measurement instrument identifiers, delimiters associated with the settings of the measurement instrument, and information units associated with settings of the measurement instrument.

18. The system according to claim 11,
wherein the data includes basic information comprising at least one of the measured value, an identifier of the measured value, a physical unit of the measured value, and a measurement time, and
wherein the data further includes delimiters for delimiting basic units in the data, special symbols, measurement instrument identifiers, delimiters associated with the settings of the measurement instrument, and information units associated with settings of the measurement instrument.

19. The system according to claim 16,
wherein the data includes basic information comprising at least one of the measured value, an identifier of the measured value, a physical unit of the measured value, and a measurement time, and
wherein the data further includes delimiters for delimiting basic units in the data, special symbols, measurement instrument identifiers, delimiters associated with the settings of the measurement instrument, and information units associated with settings of the measurement instrument.
